(19) United States
(12) Patent Application Publication
(10) Pub. No.: US 2005/0057693 A1
(43) Pub. Date: Mar. 17, 2005

(54) Digital clamp circuit

(75) Inventor: Toshio Nakakuki, Mizuho-Shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO.,LTD.

(21) Appl. No.: 10/916,859

(22) Filed: Aug. 12, 2004

(30) Foreign Application Priority Data
Sep. 11, 2003 (JP) JP2003-320166

(51) Int. Cl. H04N 5/18

(52) U.S. Cl. 348/695; 348/691

(57) ABSTRACT

A digital clamp circuit is composed of a clamp circuit and a clamp level generation circuit. The clamp level generation circuit compares the average reference black level BL of a signal Y0 for each frame with a clamp level, stores the comparison result, and then updates a clamp level which is stored in accordance with the comparison results for every predetermined number of frames.

### CROSS-REFERENCE TO RELATED APPLICATIONS

The priority application Number JP2003-320166 upon which this patent application is based is hereby incorporated by reference.

### BACKGROUND OF THE INVENTION

1. Field of the Invention

The present invention relates to a digital clamp circuit for clamping a digital signal.

2. Description of Related Art

In a related art, a signal output from a CCD solid-state imaging element, which is an intermittent output signal, is converted into a consecutive signal by means of correlated double sampling (CDS), with the gain being automatically controlled by means of automatic gain control (AGC). After analog clamping of a reference black signal to a direct current potential such that the potential is within an operating range of an A/D converter circuit which will be described below, the signal is converted by the A/D converter circuit into a digital video signal. The black level of the digital video signal is corrected (digital clamping) in a digital clamp circuit, and then predetermined digital signal processing, such as digital gain or γ correction, is performed.

FIG. 4 is a schematic view showing a pixel array of a CCD solid-state imaging element. As shown in FIG. 4, the CCD solid-state imaging element 100 includes an optical black (OPB region 120 around an effective pixel region 110, and a reference black region 121 is provided on the left side (as shown in FIG. 4) of the imaging portion in the OPB region 120 (a portion which is read out as a leading edge of one horizontal period of a signal output from the CCD solid-state imaging element 100). Because the reference black region 121 is shielded from external light, a reference black signal is output from the reference black region 121 of the CCD solid-state imaging element 100, and a subject signal in accordance with information charge accumulated in a photoreceptor pixel is output from the effective pixel region of the CCD solid-state imaging element 100.

FIG. 5 shows waveform diagrams in signal processing sections each performing a signal processing with regard to an output signal from the CCD solid-state imaging element 100. In FIG. 5, the horizontal axis indicates time and the vertical axis indicates brightness. When an output signal from the CCD solid-state imaging element 100 is analog-clamped, a reference black signal substantially the same level having and a subsequent subject signal form one horizontal period 1H for each period, and a periodical series of the horizontal periods further form one frame, namely one vertical period 1V corresponding to one screen as shown in FIG. 5A. Then, a periodical series of the signals for one vertical period 1V form an analog video signal for consecutive screens.

The analog video signal is then converted into a digital signal by the A/D converter circuit to provide a digital video signal Y0 shown in FIG. 5B. FIG. 5B shows a digital-coded 8-bit signal (with a digital code value “0” to “255”). In such a case, because the level of a reference black signal changes due to an influence such as a change in temperature, the operation range of the A/D converter circuit is required to set such that a reference black signal is sure to be digital-coded. In other words, the digital code value of a reference black signal is set in an appropriate manner such that it is always greater than “0”.

Then, the average reference black level BL, which is an average of the digital code values of the reference black signals for each frame, is calculated and this is set as a clamp level CL. The average reference black level BL is obtained by averaging output signals from the reference black region on a frame-by-frame basis, and this is converted to a 8-bit digital code value having the same accuracy as the subject signal.

In a digital clamp circuit, the digital video signal Y0 is clamped by subtraction of an amount corresponding to the clamp level CL, to provide a digital video signal Y1 as shown in FIG. 5C. Thus, the average reference black level BL calculated for each frame corresponds to a clamp level for each frame. For example, the average reference black level BL(1) for the frame T1 corresponds to the clamp level CL for the frame T1, and the average reference black level BL(2) for the frame T2 corresponds to the clamp level CL for the frame T2. When high speed processing of a video signal is required, the average reference black level BL calculated for each frame is used as a clamp level CL for the next frame. In such a case, the average reference black level BL(1) for the frame T1 is used as a clamp level for the frame T2, and the average reference black level BL(2) for the frame T2 is used as a clamp level for the frame T3, for example.

FIG. 6 schematically shows a digital-coded reference black signal. Because an average reference black level BL is an average of the reference black signals for each frame, variation of an average reference black level BL is less than variation of a reference black signal by itself. However, because a reference black signal originally contains a noise component, it is not possible to completely suppress the variation, even using the average reference black level BL. In particular, when a reference black signal has an analog value near the digital code boundary at the time of A/D conversion, the reference black signal, when digital-coded, tends to vary, which further results in variation of the average reference black level BL for each frame. For example, when the analog value of a reference black signal is near the boundary where the analog value is converted to a digital code “11” or “12”, the digital code for the reference black signal becomes “11” in some cases and becomes “12” in other cases, which results in the average reference black level BL of “11” in some cases and “12” in other cases.

Such variation in the average reference black level BL causes the digital code value of a subject signal after digital clamping to also vary, which leads to a problem of so-called hunting in which brightness varies on a frame-by-frame basis. Further, when a digital signal processing such as digital gain or γ correction is performed based on the digital video signal Y1 which has been subjected to digital clamping as described above, a code shift of “1” in the digital code would be emphasized in multiples, which further emphasizes the hunting state.

It is therefore necessary to prevent hunting caused by variation of the clamp level on a frame-by-frame basis in the digital clamp circuit, thereby stabilizing display of an output signal from the solid-state imaging element.

### SUMMARY OF THE INVENTION

In accordance with one aspect of the present invention, there is provided a digital clamp circuit for clamping a digital video signal which represents a subject image in frame units, a reference black signal and a subject signal periodically appearing for each frame of the digital video signal, the digital clamp circuit comprising a clamp circuit for clamping the reference black signal of the digital video signal to a predetermined level, and a clamp level generation circuit for generating a clamp level by which clamping is performed in the clamp circuit, wherein the clamp level generation circuit includes a comparator circuit for comparing the reference black signal for a plurality of frames with an existing clamp level.

### BRIEF DESCRIPTION OF THE DRAWINGS

Preferred embodiments of the present invention will be described in further detail based on the following drawings, wherein:

FIG. 1 is a block diagram showing the structure of a digital clamp circuit according to a first embodiment of the present invention;

FIG. 2 is a flowchart of operations in a determination circuit according to the first embodiment of the present invention;

FIG. 3 is a block diagram showing the structure of a digital clamp circuit according to a second embodiment of the present invention;

FIG. 4 is a schematic view of a pixel arrangement of a CCD solid-state imaging element;

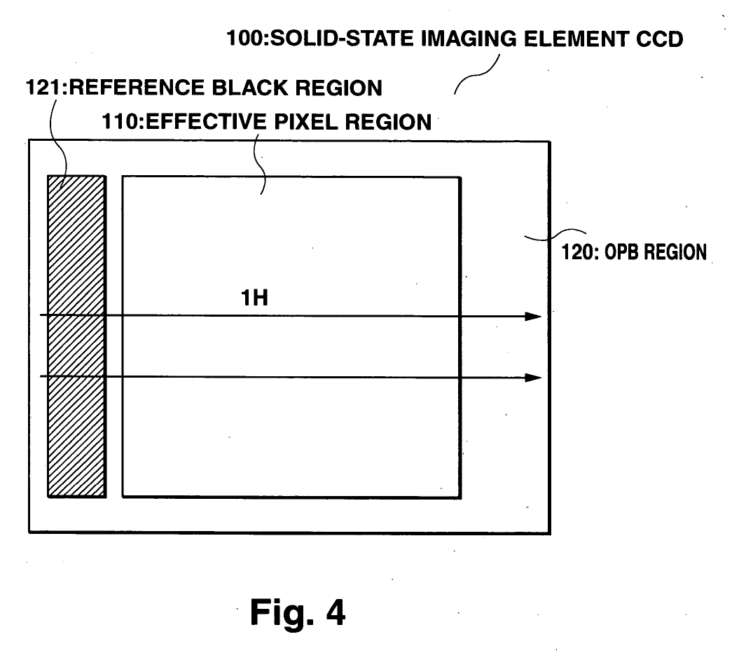

FIG. 5A, FIG. 5B and FIG. 5C are waveform diagrams in each signal processing section in which an output signal from a CCD solid-state imaging element is processed; and

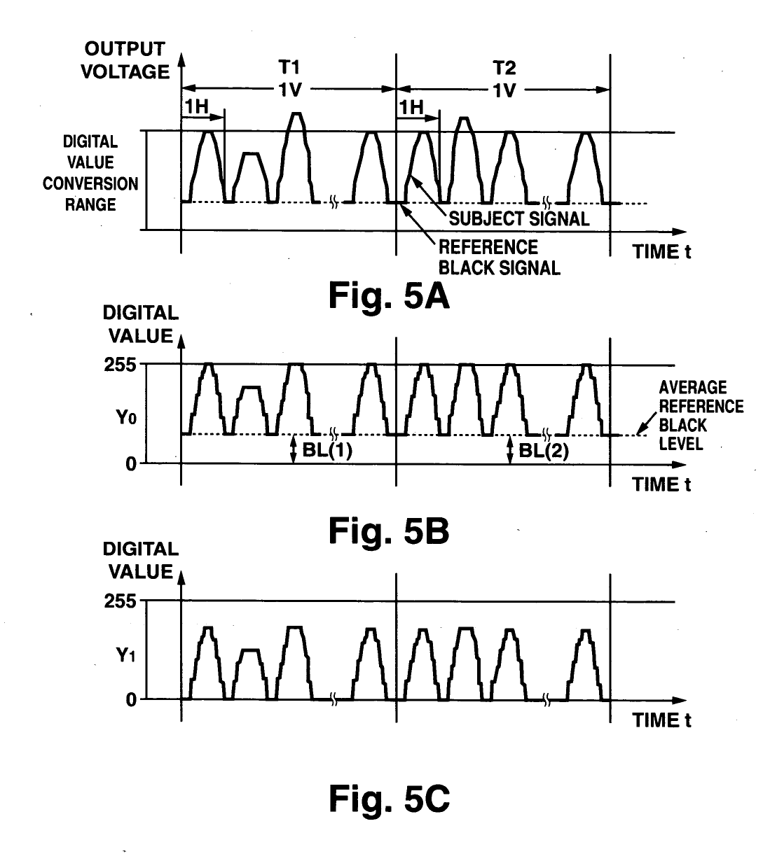

FIG. 6 is an explanatory view for a reference black signal and the average reference black level.

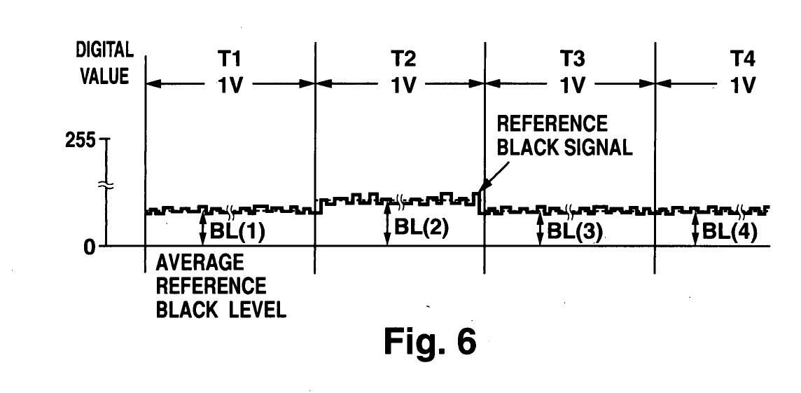

### DETAILED DESCRIPTION OF PREFERRED EMBODIMENTS

Preferred embodiments of the present invention will be described in further detail with reference to the accompanying drawings.

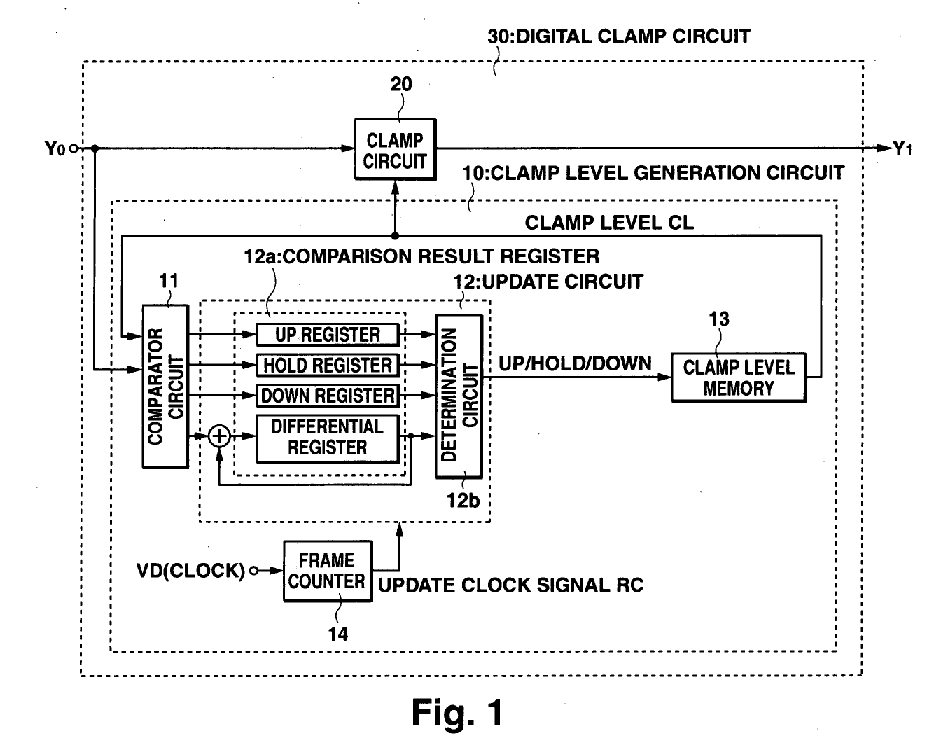

FIG. 1 is a block diagram showing a structure of a digital clamp circuit 30 in accordance with a first embodiment of the present invention. The digital clamp circuit 30 is composed of a clamp circuit 20 and a clamp level generation circuit 10. The clamp level generation circuit 10 is composed of a comparator circuit 11, an update circuit 12, a clamp level memory 13, and a frame counter 14. The update circuit 12 further includes a comparison result register 12a composed of an up register, a hold register, a down register, and a differential register, and a determination circuit 12b.

A vertical driver signal VD which is generated for each frame is input to the frame counter 14, which outputs an update clock signal RC to the update circuit 12 for every predetermined number of frames, thereby resetting the register value of the comparison result register 12a to “0”.

In the clamp level memory 13 is pre-stored a clamp level CL of a total of 10 bits including a 8-bit integer portion and a 2-bit decimal portion. The 10-bit data is input, as a clamp level CL, to the clamp circuit 20, where a digital video signal Y0 is digital-clamped by an amount corresponding to the clamp level CL. The clamp level CL is also input to the comparator circuit 11, to which a digital video signal Y0 having a 8-bit integer portion is further input. The comparator circuit 11 calculates an average output signal of the reference black region from the digital video signal Y0 to generate an average reference black level BL of a total of 10 bits including a 8-bit integer portion and a 2-bit decimal portion. The average reference black level BL is a digital code value having a higher accuracy of “0.25” than a subject signal. The comparator circuit 11 then compares the average reference black level BL with the clamp level CL.

The average reference black level BL and the clamp level CL are compared on a frame-by-frame basis by the comparator circuit 11. As a result of comparison, when the average reference black level BL is greater than the clamp level CL by a predetermined set value or more, the register value of the up register is increased by “+1”. When the average reference black level BL is smaller than the clamp level CL by a predetermined set value or more, the register value of the down register is increased by “+1”. When the difference between the average reference black level BL and the clamp level CL is a predetermined set value or less, the register value of the hold register is increased by “+1”. Further, the difference between the average reference black level BL and the clamp level CL is added to the register value already held in the differential register to update the register value of the differential register. Thus, a value obtained by accumulation of past differences is held in the differential register.

Then, when a new update clock signal RC is input to the update circuit 12 by the frame counter 14, the determination circuit 12b performs a determination operation, and after the determination operation, the register value of the comparison result register 12a is reset once again. At this time, the determination circuit 12b, receiving an update clock signal RC, performs a determination operation for performing either up, hold, or down of the clamp level CL stored in the clamp level memory 13 based on the contents of the comparison result register 12a, and overwrites the current clamp level CL and stores a new clamp level CL which is a result of the determination operation in the clamp level memory 13. Consequently, digital clamping of the subsequent digital video signals Y0 will be performed using the new clamp level CL which is written and stored in the clamp level memory 13 as described above.

Thereafter, for each update clock signal RC supplied from the frame counter 14, the determination circuit 12b similarly updates the clamp level CL stored in the clamp level memory 13 based on the contents of the comparison result register 12a.

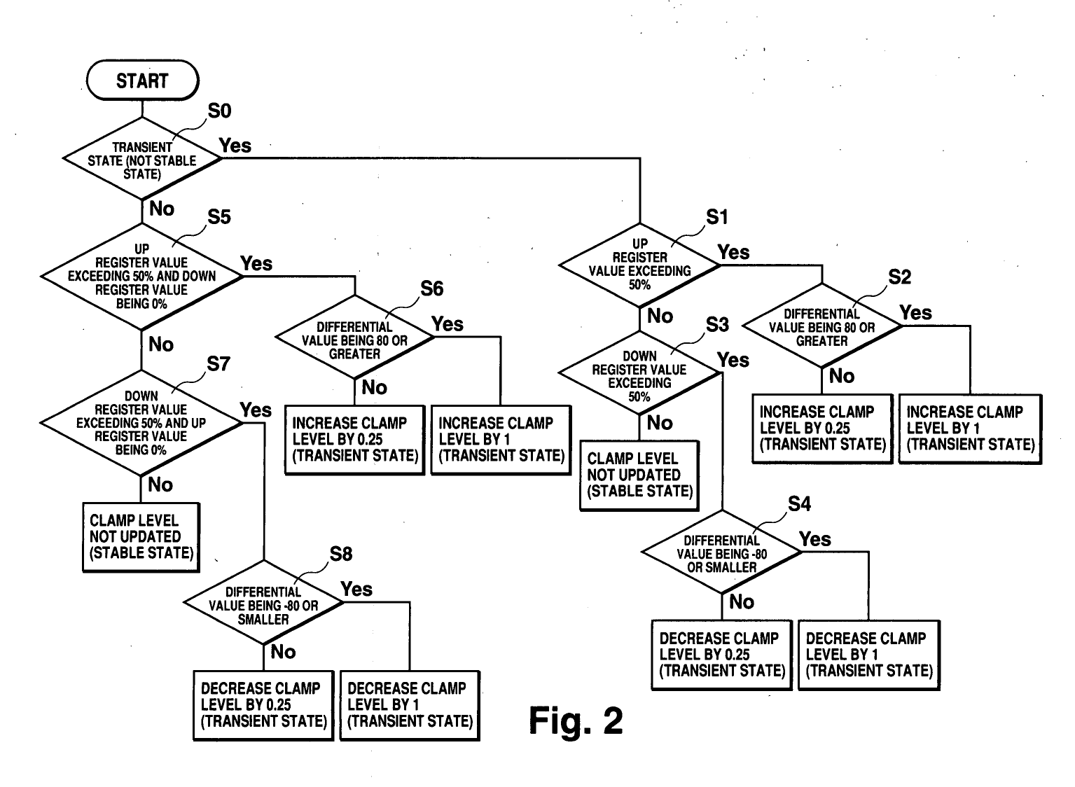

FIG. 2 is an example flowchart of the determination operation performed by the determination circuit 12b. Every time the count number of the frame counter 14 reaches a determined number of frames, an update clock signal RC is input to the update circuit 12 where the determination circuit 12b repeats the determination operation. In this embodiment, the predetermined number of frames is set to 20.

In the determination operation of the present embodiment, different determination operations are used between a stable state and a transient state. More specifically, the clamp level CL is increased and decreased in a relatively simple manner in the transient state, whereas, once it is determined that a stable state exists, the clamp level remains unchanged to the extent possible. The determination circuit 12b includes a flag indicating the stable state or the transient state, and the transient state is set as an initial setting immediately after the start of image capturing.

First, at step S0, it is determined whether the state is a stable state or a transient state by means of the flag of the determination circuit 12b. The process proceeds to step S1 when it is determined that a transient state exists, and the process proceeds to step S5 when it is determined that a stable state exists.

When the flag of the determination circuit 12b is set to a transient state, at step S1, it is determined whether or not the register value of the up register exceeds 50% of the predetermined number of frames, namely whether or not the register value is “11” or more. If the determination is Yes, the process proceeds to step S2, and, if NO, the process proceeds to step S3. When the register value of the differential register is “80” or greater at step S2, the clamp level is increased by “1”. When the register value of the differential register is less than “80” at step S2, the clamp level is increased by “0.25”. In either case, the flag maintains setting of a transient state. Here, the fact that register value of the differential register is “80” or greater indicates that the average reference black level BL is greater than the clamp level CL by “4” or more on a frame average. Accordingly, the clamp level CL is increased by “1”, so that the clamp level CL is made to approach the average reference black level BL immediately. On the other hand, the fact that register value of the differential register is less than “80” indicates that the difference between the average reference black level BL and the clamp level CL is less than “4” on a frame average. Accordingly, the clamp level CL is increased by “0.25”, so that the clamp level CL is made to approach the average reference black level BL slowly.

Next, at step S3, when the register value of the down register exceeds 50% of the predetermined number of frames, namely the register value is “11” or greater, the process proceeds to step S4, whereas, when the register value is less than “11”, the clamp level is not updated and the setting of the flag is changed from a transient state to a stable state. At step S4, when the register value of the differential register is “−80” or less, the clamp level is decreased by “1”, whereas when the register value is greater than “−80”, the clamp level is decreased by “0.25”. In either case, the flag retains the setting of the transient state. Here, the fact that register value of the differential register is “−80” or smaller indicates that the average reference black level BL is smaller than the clamp level CL by “4” or more on a frame average. Accordingly, the clamp level CL is decreased by “1”, so that the clamp level CL is made to approach the average reference black level BL immediately. On the other hand, the fact that register value of the differential register is greater than “−80” indicates that the difference between the average reference black level BL and the clamp level CL is less than “4” on a frame average. Accordingly, the clamp level CL is decreased by “0.25”, so that the clamp level CL is made to approach the average reference black level BL slowly.

On the other hand, when the flag of the determination circuit 12b indicates a stable state, not to a transient state, it is determined, at step S5, whether or not the register value of the up register exceeds 50% of the predetermined number of frames, namely whether or not the register value is “11” or greater, and also whether or not the register value of the down register is “0”. If Yes, the process proceeds to step S6, whereas if No, the process proceeds to step S7. At step S6, when it is determined that the register value of the differential register is “80” or greater, the clamp level is increased by “1”, whereas, when it is determined that the register value is less than “80”, the clamp level is increased by “0.25”. In either case, the setting of the flag is changed from a stable state to a transient state.

At step S7, it is determined whether or not the register value of the down register exceeds 50% of the predetermined number of frames, namely whether or not the register value is “11” or greater, and also whether or not the register value of the up register is “0”. If Yes, the process proceeds to step S8, whereas if No, the clamp level is not updated and the flag maintains the setting of the stable state. At step S8, when the register value of the differential register is “−80” or smaller, the clamp level is decreased by “1”, whereas the register value is greater than “−80”, the clamp level is decreased by “0.25”. In either case, the setting of the flag is changed from a stable state to a transient state.

As described above, the determination operation is performed based not only on the register value of the differential register, but the register values of the up and down registers are also used for the determination operation. Consequently, even when a significant noise is included in a part of a reference black signal and the register value of the differential register varies significantly, variation of the clamp level caused by the noise can be suppressed because such a noise would not have a large effect on the register values of the up register and the down register. In addition, the determination operation is performed separately and in different manners in the transient state and in the stable state. More specifically, the increase and decrease of the clamp level is less in the stable state than in the transient state, and once the stable state is established, a change of the clamp level is suppressed.

The flowchart of the determination operation in FIG. 2 is shown only for an illustrative purpose, and the determination operation may be appropriately set such that the hunting problem can be eliminated. For example, it is possible that the determination operation is not performed separately between the transient state and for the stable state, and that the determination flow from steps S1 to S4 or steps S5 to S8 is performed. Further, in the determination operation shown in FIG. 2, the up register, the down register, and the differential register are used, whereas the hold register is not used. It is of course possible, however, to use the hold register, or to perform the determination operation using only the differential register.

Further, while in the above-described example shown in FIG. 2 the reference values for determination are the register value of the up register exceeding 50% of the predetermined number of frames at step S1 and the register value of the down register exceeding 50% of the predetermined number of frames at step S3, or the register value of the up register exceeding 50% of the predetermined number of frames and the register value of the down register being “0” at step S5 and the register value of the down register exceeding 50% of the predetermined number of frames and the register value of the up register being “0” at step S7, these values can be set as desired.

In addition, while in the above example the clamp level is increased or decreased by “1” when the register value of the differential register is “80” or more, or “−80” or less, it is also possible to increase or decrease the clamp level by the number obtained by dividing the register value of the differential register by the predetermined number of frames.

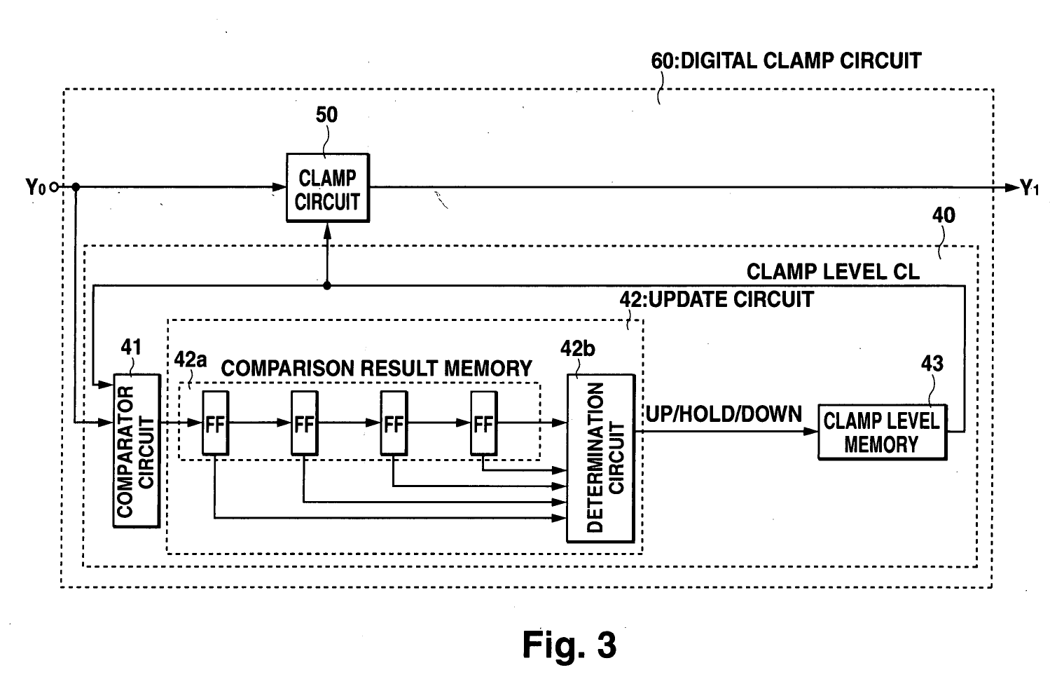

FIG. 3 is a block diagram showing a structure of a digital clamp circuit 60 according to a second embodiment of the present invention. The digital clamp circuit 60 is composed of a clamp circuit 50 and a clamp level generation circuit 40. The clamp level generation circuit 40 is composed of a comparator circuit 41, an update circuit 42, and a clamp level memory 43. The update circuit 42 further includes a comparison result memory 42a, and a determination circuit 42b. The clamp circuit 50, the comparator circuit 41, and the clamp level memory 43 have structures similar to the clamp circuit 20, the comparator circuit 11, and the clamp level memory 13 of FIG. 1, respectively.

The comparison result memory 42a sequentially stores, as differential data, a difference between an average reference black level BL for a predetermined number of frames and a clamp level CL. The comparison result memory 42a includes, for example, a shift register formed by a flip-flop, a ring buffer memory, or the like. The determination circuit 42b updates, on a frame-by-frame basis, the clamp level CL stored in the clamp level memory 43 based on the differential data for the predetermined number of frames including the corresponding frame and the previous frames, which is stored in the comparison result memory 42a. In such a case, the determination operation of the determination circuit 42b may follow the flowchart shown in FIG. 2, or may be such that update of the clamp level is determined based on the average of the differential data excluding the maximum and minimum values. In other words, any determination method may be used as long as the clamp level is updated based on the comparison between the average reference black level among a plurality of frames and the clamp level CL, in order to suppress variation of the reference black signal caused by the influence of noise.

According to the present embodiments, as the clamp level of digital clamping is calculated from the reference black signal for a plurality of frames, variation of the clamp level due to the noise can be suppressed and the hunting state can be overcome. At this point, by allowing the clamp level to be updated only every plurality of frames, frequent variation of the clamp level caused when the clamp level is updated for each frame can be eliminated, thereby further overcoming the hunting problem. On the other hand, by updating the clamp level on a frame-by-frame basis using the average reference black signal among a plurality of the past frames, the hunting state can be overcome and also the clamp level can be made to immediately correspond to a change in the level of the reference black signal due to a temperature change, even when such a change occurs.

While in both the first and second embodiments as described above, the comparator circuit 11 or 41 compares the average reference black level BL with the clamp level CL, the present invention is not limited to such a structure. For example, it is also possible that a reference black signal and a clamp level are sequentially compared and then averaged, and that the result is transferred to the update circuit 12 or 42 for each a frame.

Further, while in the above examples the value of the clamp level CL is made to be as close to the average reference black level BL as possible using the comparison results among a plurality of frames, the clamp level CL and the black level BL need not necessarily be equal. In other words, while the digital value of the reference black signal after digital clamping is made to become “0” in the present invention, any value other than “0” may also be used.

While the preferred embodiments of the present invention have been described using specific terms, such description is for illustrative purposes only, and it is to be understood that changes and variations may be made without departing from the spirit or scope of the appended claims.

1. A digital clamp circuit for clamping a digital video signal which represents a subject image in frame units, a reference black signal and a subject signal periodically appearing for each frame of the digital video signal, the digital clamp circuit comprising:
a clamp circuit for clamping the reference black signal of the digital video signal to a predetermined level; and
a clamp level generation circuit for generating a clamp level by which clamping is performed in the clamp circuit,
wherein the clamp level generation circuit includes a comparator circuit for comparing the reference black signal for a plurality of frames with an existing clamp level.

2. A digital clamp circuit according to claim 1, wherein
the clamp level generation circuit updates the clamp level based on a comparison result of the comparator circuit.

3. A digital clamp circuit according to claim 1, wherein
the clamp level generation circuit includes:
a clamp level memory for storing the clamp level; and
an update circuit for updating the clamp level stored in the clamp level memory based on a comparison result of the comparator circuit.

4. A digital clamp circuit according to claim 3, wherein
the update circuit includes:
a comparison result register for storing the comparison result of the comparison circuit as a register value;
a determination circuit for updating the clamp level stored in the clamp memory based on the register value of the comparison result register; and
a frame counter for causing the determination circuit to operate and also outputting an update clock signal for resetting the comparison result register for every said plurality of frames.

5. A digital clamp circuit according to claim 3, wherein
the update circuit includes:
a comparison result memory for storing the comparison results of the comparator circuit corresponding to a plurality of frames; and
a determination circuit for updating the clamp level stored in the clamp level memory based on a content of the comparison result memory.
